(19) United States
(12) Patent Application Publication
(10) Pub. No.: US 2023/0253639 A1
(43) Pub. Date: Aug. 10, 2023

(54) BATTERY PACK INERT GAS FLOW SYSTEM

(71) Applicant: GM GLOBAL TECHNOLOGY OPERATIONS LLC, Detroit, MI (US)

(72) Inventors: Thomas J. CHAPATON, Sterling Heights, MI (US); Nicholas Paul William PIECZONKA, Windsor (CA); Ratandeep Singh KUKREJA, Warren, MI (US)

(73) Assignee: GM GLOBAL TECHNOLOGY OPERATIONS LLC, Detroit, MI (US)

(21) Appl. No.: 17/668,863

(22) Filed: Feb. 10, 2022

(51) Int. Cl. H01M 10/52

(52) U.S. Cl. CPC H01M 10/52; H01M 2220/20

(57) ABSTRACT

A battery system includes a battery housing having an interior compartment. A battery pack, including a plurality of battery cells, is in the interior compartment of the housing. A vessel defines an interior chamber and includes an air inlet, an oxygen discharge port, and an inert gas discharge port each in communication with the interior chamber. An oxygen separation material is in the chamber and is configured to separate oxygen from air supplied through the air inlet and to direct the oxygen to the oxygen discharge port. The oxygen separation material is further configured to direct remaining oxygen deficient air to the inert gas discharge port. The inert gas discharge port in communication with the interior compartment of the battery housing.

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Lithium-ion electrochemical or batteries typically comprise a plurality of cells that may be electrically connected in a stack to increase overall output. In particular, the battery cells may include alternating positive electrodes and negative electrodes with separators disposed there between to define a stack. These battery cells thus form battery modules. The modules may be assembled into a battery pack that is disposed in an encasement or battery housing or cover.

Battery units have high energy density that produce heat. Overheating, shorting due to SEI growth, Li biproduct formation and shorting, or over charging could lead to thermal runaway. Safety features usually have been incorporated in lithium-ion batteries, including shut-down separators, vents for pressure relief and thermal interrupts, but not all cells use these features and contaminants, and other external events can override the safety features. The present disclosure provides a new and non-obvious approach to preventing ignition, flame propagation, fire, and possible explosion within battery cases (outside pouches); due to a build-up of flammable gasses, such as battery solvent vapors and off-gassing polymer VOCs, in an enclosed space. However, during a thermal runaway propagation (TRP) event, it would be advantageous if the housing is supplied with an inert gas that can both cool the battery cells and prevent combustion.

### SUMMARY

This section provides a general summary of the disclosure, and is not a comprehensive disclosure of its full scope or all of its features.

The present disclosure relates to a battery pack active inert gas supply system.

According to an aspect of the present disclosure, a battery system includes a battery housing having an interior compartment. A battery pack, including a plurality of battery cells, is in the interior compartment of the housing. A vessel defines an interior chamber and includes an air inlet, an oxygen discharge port, and an inert gas discharge port each in communication with the interior chamber. An oxygen separation material is in the chamber and is configured to separate oxygen from air supplied through the air inlet and to direct the oxygen to the oxygen discharge port. The oxygen separation material is further configured to direct remaining oxygen deficient air to the inert gas discharge port. The inert gas discharge port in communication with the interior compartment of the battery housing.

According to a further aspect, the oxygen separation material is a hollow fiber membrane.

According to a further aspect, a compressor is configured to supply pressurized air to the air inlet of the vessel.

According to a further aspect, a controller operatively controls the compressor based upon operating conditions of the battery pack.

According to a further aspect, the vessel is a cylindrical cannister.

According to yet another aspect, a vehicle includes a vehicle frame supported by a plurality of wheels. A battery housing is supported by the vehicle frame and has an interior compartment. A battery pack includes a plurality of battery cells in the interior compartment. A vessel defines an interior chamber and has an air inlet, an oxygen discharge port, and an inert gas discharge port each in communication with the interior chamber. An oxygen separation material is in the chamber and is configured to separate oxygen from air supplied through the air inlet and to direct the oxygen to the oxygen discharge port. The oxygen separation material is further configured to direct remaining oxygen deficient air to the inert gas discharge port. The inert gas discharge port is in communication with the interior compartment of the battery housing.

According to yet another aspect, a battery system, includes a battery housing having an interior compartment. A battery pack includes a plurality of battery cells in the interior compartment. A vessel defines an interior chamber and has an air inlet, an oxygen discharge port, and an inert gas discharge port each in communication with the interior chamber. An oxygen separation material is in the chamber and configured to separate oxygen from air supplied through the air inlet and to direct the oxygen to the oxygen discharge port. The oxygen separation material is configured to direct remaining oxygen deficient air to the inert gas discharge port. A storage chamber is in communication with the inert gas discharge port for storing pressurized inert gas therein. The storage chamber is in selective communication with the interior compartment of the battery housing to supply pressurized oxygen deficient air to the interior compartment. A control unit is configured to monitor operational conditions of the battery pack and to activate a valve to deliver pressurized oxygen deficient air from the storage chamber and to the interior compartment of the battery housing.

The present disclosure proposes an active inert gas supply system within a battery case that is capable of supplying inert gas to the chamber within the battery housing. An active suppression system may be continuous and/or activated by measuring several feedback mechanisms within the battery case (e.g., temperature, liquid detection, and electronic systems).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of an inert gas continuous flow system for a battery pack according to the principles of the present disclosure;

FIG. 2 is a partially cut-away perspective view of an inert gas separator according to the principles of the present disclosure; and

FIG. 3 is a schematic view of an inert gas on-demand flow system for a battery pack according to the principles of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

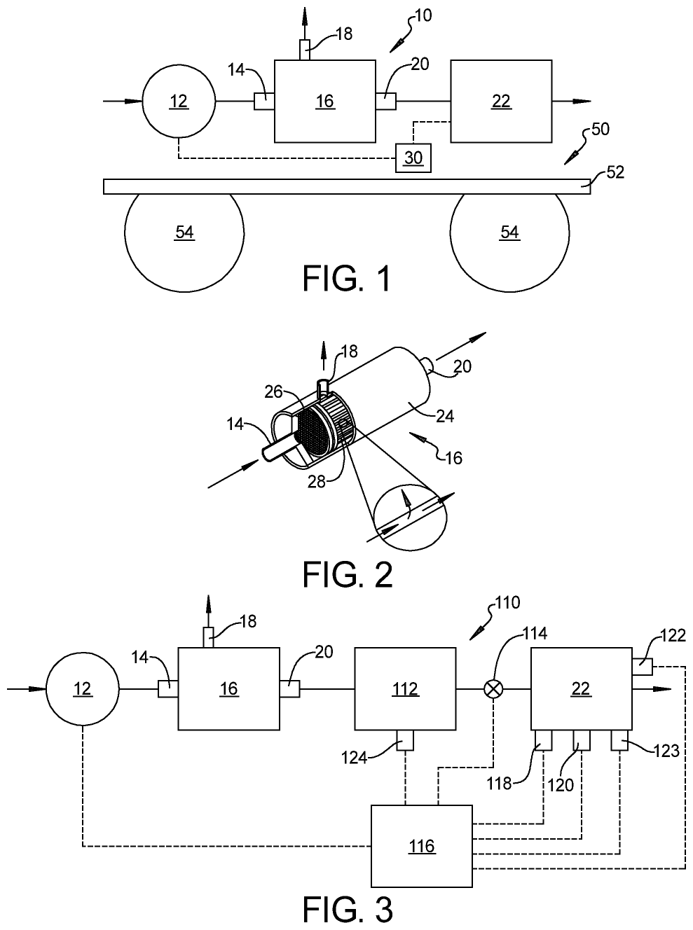

With reference to FIG. 1, an inert gas continuous flow system 10 for a battery pack is shown. The inert gas continuous flow system 10 includes a compressor 12 that supplies compressed atmospheric air to an inlet 14 of an oxygen separator device 16. The oxygen separator device 16 separates a portion of oxygen-containing species (e.g., O₂, CO₂, H₂O) from the compressed air supply and discharges the separated oxygen from an oxygen discharge port 18. The remaining and oxygen deprived air is discharged from an inert gas discharge port 20 and delivered into a housing of a battery pack 22 that includes a plurality of battery cells. The inert gas system minimizes a concentration of oxidant species (e.g., oxygen (O₂) gas) introduced into the battery pack and thus may correspondingly mitigate potential reaction of battery solvent vapor and polymer VOC from off-gassing, permitting higher concentrations of the battery solvent vapor and polymer VOC's to be present. The same inert flow can also act as a nitrogen-enriched air (NEA) purge flow cooling system for removing generated battery pouch heat contributions. The same inert flow can mitigate potential reaction between VOC's and air in the presence of pouch heat that can result in thermal runaway event. A control unit 30 can be provided for controlling operation of the compressor 12 at predetermined or intermittent times while the battery pack 22 is operational.

The inert gas continuous flow system 10 can be employed on a vehicle 50 (generically shown in FIG. 1) that can include a vehicle frame 52 and a plurality of wheels 54. The inert gas continuous flow system 10 can be supported on the vehicle frame 52. It should be understood that the vehicle can take on numerous forms including electric vehicles, hybrid-electric vehicles, hydrogen fuel-cell vehicles and engine powered vehicle. The vehicles can be in the form of automobiles, trucks, SUVs (sport utility vehicles) and motorcycles. In addition, the vehicles can be land, water, or airborne vehicles.

With reference to FIG. 2, the oxygen separator device 16 can include a vessel 24 having an internal chamber 26 in communication with the air inlet 14, the oxygen discharge port 18 and the inert gas discharge port 20. The vessel 24 can be in the form of a cylindrical cannister. A hollow fiber membrane 28 is disposed in the internal chamber 26. The hollow fiber membrane 28 separates oxygen and oxygen-containing species in the air by allowing the nitrogen molecules (smaller size) to pass through it and not the oxygen or oxygen-containing molecules (larger size). Accordingly, the hollow fiber membrane 28 separates the supplied compressed air into 1) oxygen and 2) nitrogen-enriched and oxygen deprived inert gas, and the vessel 24 discharges the oxygen from the oxygen discharge port 18 and discharges the nitrogen-enriched and oxygen deprived air through the inert gas discharge port 20. The hollow fiber membrane material 28 inside the vessel 24 separates the supplied air (generally having approximately 21% by volume oxygen, 78% by volume nitrogen, and about 1% by volume other constituents) into nitrogen-enriched air (NEA) having greater than or equal to about 88 to less than or equal to about 92% by volume nitrogen and oxygen deprived air (ODA) greater than or equal to about 8 to less than or equal to about 12% by volume oxygen.

According to an alternative embodiment as shown in FIG. 3, an inert gas on-demand flow system 110 for a battery pack is shown. The inert gas continuous flow system 110 includes a compressor 12 that supplies compressed air to an inlet 14 of an oxygen separator device 16. The oxygen separator device 16 separates oxygen from the compressed air supply and discharges the separated oxygen from an oxygen discharge port 18. The remaining oxygen deficient air is discharged from an inert gas discharge port 20 and delivered to a storage device 112 that stores the pressurized inert gas. A battery pack 22 is in selective communication with the storage device 112 by a valve 114 or other control device. A control unit 116 can be provided in communication with various sensors that can include but is not limited to a temperature sensor 118, a liquid detection sensor 120, a gas sensor 122 and electronic system anomaly detection sensor 123 that can provide signals to the control unit 116. The control unit 116, upon receipt of a signal that is indicative of a thermal runaway or other potential damaging condition, will activate the valve 114 to supply a burst of inert gas into the housing of the battery pack 22 to provide a nonflammable environment when activated. The amount of stored compressed oxygen deficient air can be sufficient to replace existing air within the battery housing. The control unit 116 also can control the compressor 12 to refill the storage device 112 with inert gas after the pressurized inert gas has been discharged to the battery pack 22. The storage device 112 can include a pressure sensor 124 for providing pressure signals to the control unit 116 to allow the control unit to determine when the storage device 112 needs to be refilled.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery system, comprising:
a battery housing having an interior compartment;
a battery pack, including a plurality of battery cells, in the interior compartment of the housing;
a vessel defining an interior chamber and having an air inlet, an oxygen discharge port, and an inert gas discharge port each in communication with the interior chamber and an oxygen separation material in the chamber and configured to separate oxygen from air supplied through the air inlet and to direct the oxygen to the oxygen discharge port, the oxygen separation material further configured to direct remaining oxygen deficient air to the inert gas discharge port; and
the inert gas discharge port in communication with the interior compartment of the battery housing.

2. The battery system according to claim 1, wherein the oxygen separation material is a hollow fiber membrane.

3. The battery system according to claim 1, further comprising a compressor configured to supply pressurized air to the air inlet of the vessel.

4. The battery system according to claim 3, further comprising a controller operatively controlling the compressor based upon operating conditions of the battery pack.

5. The battery system according to claim 1, wherein the vessel is a cylindrical cannister.

6. A vehicle, comprising:
a vehicle frame;
a battery housing supported by the vehicle frame and having an interior compartment;
a battery pack, including a plurality of battery cells, in the interior compartment;
a vessel defining an interior chamber and having an air inlet, an oxygen discharge port, and an inert gas discharge port each in communication with the interior chamber and an oxygen separation material in the chamber and configured to separate oxygen from air supplied through the air inlet and to direct the oxygen to the oxygen discharge port, the oxygen separation material further configured to direct remaining oxygen deficient air to the inert gas discharge port; and
the inert gas discharge port in communication with the interior compartment of the battery housing.

7. The vehicle according to claim 6, wherein the oxygen separation material is a hollow fiber membrane.

8. The vehicle according to claim 6, further comprising a compressor configured to supply pressurized air to the air inlet of the vessel.

9. The vehicle according to claim 8, further comprising a controller operatively controlling the compressor based upon operating conditions of the battery pack.

10. The vehicle according to claim 6, wherein the vessel is a cylindrical cannister.

11. A battery system, comprising:
a battery housing having an interior compartment;
a battery pack, including a plurality of battery cells, in the interior compartment;
a vessel defining an interior chamber and having an air inlet, an oxygen discharge port, and an inert gas discharge port each in communication with the interior chamber and an oxygen separation material in the chamber and configured to separate oxygen from air supplied through the air inlet and to direct the oxygen to the oxygen discharge port, the oxygen separation material further configured to direct remaining oxygen deficient air to the inert gas discharge port;
a storage chamber in communication with the inert gas discharge port for storing pressurized inert gas therein, the storage chamber being in selective communication with the interior compartment of the battery housing to supply pressurized oxygen deficient air to the interior compartment; and
a control unit configured to monitor operational conditions of the battery pack and to activate a valve to deliver pressurized oxygen deficient air from the storage chamber and to the interior compartment of the battery housing.

12. The battery system according to claim 11, wherein the oxygen separation material is a hollow fiber membrane.

13. The battery system according to claim 11, further comprising a compressor configured to supply pressurized air to the air inlet of the vessel.

14. The battery system according to claim 13, further comprising a controller operatively controlling the compressor based upon operating conditions of the battery pack.

15. The battery system according to claim 11, wherein the vessel is a cylindrical cannister.
